(19) United States
(12) Patent Application Publication
(10) Pub. No.: US 2012/0284661 A1
(43) Pub. Date: Nov. 8, 2012

(54) MAP INFORMATION PROCESSING DEVICE

(76) Inventors: Makoto Mikuriya, Tokyo (JP); Tomohiro Nakae, Tokyo (JP); Mitsuo Shimotani, Tokyo (JP); Kazutoshi Hayashi, Tokyo (JP); Yasushi Kodaka, Tokyo (JP)

(21) Appl. No.: 13/519,490

(22) PCT Filed: Apr. 5, 2010
(86) PCT No.: PCT/JP2010/002478

§ 371 Date: Jun. 27, 2012

(51) Int. Cl. G06F 3/048

(52) U.S. Cl. 715/780

(57) ABSTRACT

A map information processing device extracts objects having a relation therebetween which satisfies a predetermined requirement from among objects each of which is a search target, and selects an object which the user desires from among the objects extracted thereby by prompting the user to input the name of one of the objects according to a row of characters defined by identifier character information showing the row of a predetermined number of characters from the head of a character string showing the name of the object.

### FIELD OF THE INVENTION

The present invention relates to a map information processing device which is applied to, for example, a navigation device. More particularly, it relates to a map information processing device which provides an improvement in its ease of use regarding input of a name such as the name of a destination.

### BACKGROUND OF THE INVENTION

A device disclosed, as a conventional map information processing device, by, for example, patent reference 1 has street search data in which the names of streets are arranged in an alphabetical order, and, when the user inputs a street name, displays characters which can be inputted the next time by selecting them from the street search data every time when the user inputs a character. The user selects his or her desired character from among the characters which are displayed in this way, and inputs the desired character to the device.

More specifically, in order to determine characters which can be inputted the next time when the user inputs the N-th character (N=1, 2, 3, . . . ), the device searches for the names of all the streets registered in the street search data, and extracts the N-th character of the name of each of all the streets.

Further, in order to determine an intersection where two streets intersect, the device disclosed by patent reference 1 provides intersection data in which a set of street names is stored, and intersection conversion data showing the position of an intersection corresponding to the intersection data for each of all sets of two streets.

In order to determine an intersection, the conventional device inputs two street names by using the above-mentioned method, and searches through the intersection data for a set of the inputted street names to determine the position corresponding to the intersection from the intersection conversion data.

As mentioned above, the conventional device disclosed by patent reference 1 searches through the names of all the streets registered in the street search data in order to determine the characters which can be inputted the next time when the user inputs a street name. Therefore, a problem is that it takes time for the conventional device to present the characters which can be inputted to the user, and it takes a long time for the user to input a street name.

Further, when determining an intersection where two streets intersect through a map information process, the conventional device disclosed by patent reference 1 inputs the names of the two streets by using the same method. Therefore, a problem is that because at the time of inputting the name of the second street, it takes the same time as that at the time of inputting the name of the first street for the conventional device to search through the names of all the streets and present the characters which can be inputted to the user, it takes a long time for the user to input the name of the second street.

The present invention is made in order to solve the above-mentioned problems, and it is therefore an object of the present invention to provide a map information processing device which can shorten the time required to determine the characters which can be inputted thereto the next time when the user inputs the name of an object, thereby being able to improve its ease of use for input of a name.

### RELATED ART DOCUMENTS

### Patent Reference

Patent reference 1: Japanese Unexamined Patent Application Publication No. 2008-139252

### SUMMARY OF THE INVENTION

In accordance with the present invention, there is provided a map information processing device including: a storage unit for storing objects each of which is a search target, object identifiers each including identifier character information showing a row of a predetermined number of characters from a head of a character string showing a name of one of the objects, and an attribute of each of the objects; an object narrowing unit for extracting objects having a relation therebetween which satisfies a predetermined requirement from among the objects stored in the storage unit; an object selecting unit for selecting an object which a user desires from among the objects extracted by the object narrowing unit by prompting the user to input a name of one of the objects according to a row of characters defined by the identifier character information; and an attribute acquiring unit for acquiring an attribute of the object selected by the object selecting unit from the storage unit as data which is used for a map information process on the object.

The map information processing device in accordance with the present invention extracts objects having a relation therebetween which satisfies a predetermined requirement from among the objects each of which is a search target, and selects an object which the user desires from among the objects extracted thereby by prompting the user to input the name of one of the objects according to the row of characters defined by the identifier character information showing the row of the predetermined number of characters from the head of the character string showing the name of the object. By doing in this way, the map information processing device provides an advantage of being able to shorten the time required to determine characters which can be inputted thereto the next time when the user inputs the name of an object, and to improve its ease of use of the input of a name.

### BRIEF DESCRIPTION OF THE FIGURES

FIG. 1 is a block diagram showing the structure of a map information processing device in accordance with Embodiment 1 of the present invention;

FIG. 2 is a block diagram showing the function configuration of a processor;

FIG. 3 is a view showing an example of search information stored in a map information storage unit;

FIG. 4 is a view showing an example of an object record;

FIG. 5 is a view showing an example of a search tree shown by first object search tree data;

FIG. 6 is a view showing an example of a related object record;

FIG. 7 is a view showing an example of a second object identifier;

FIG. 8 is a flow chart showing a flow of a search process in accordance with Embodiment 1;

FIG. 9 is a view showing an example of an input screen;

FIG. 10 is a view showing the example of presentation of inputtable characters;

FIG. 11 is a view showing an example of a second object identifier and the street name of a street located in a city having a name of “ADTC”;

FIG. 12 is a view showing the example of presentation of inputtable characters;

FIG. 13 is a view showing an example of an input screen for input of a street name;

FIG. 14 is a view for explaining a related attribute;

FIG. 15 is a block diagram showing the function configuration of a processor of a map information processing device in accordance with Embodiment 2 of the present invention;

FIG. 16 is a flow chart showing a flow of an object selection process in accordance with Embodiment 2;

FIG. 17 is a view showing an example of a list display unit in an input screen;

FIG. 18 is a view showing an example of the list display unit after a character input is done; and

FIG. 19 is a view showing an example of first character string information in Embodiment 3.

### EMBODIMENTS OF THE INVENTION

Hereafter, in order to explain this invention in greater detail, the preferred embodiments of the present invention will be described with reference to the accompanying drawings.

### Embodiment 1

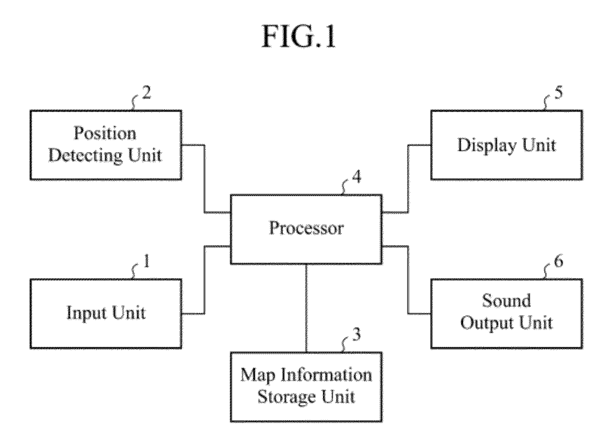

FIG. 1 is a block diagram showing the structure of a map information processing device in accordance with Embodiment 1 of the present invention. In the map information processing device shown in FIG. 1, an input unit 1 is a group of operation switches which provides a command signal to a processor 4 according to a user's operation or a user command, and which functions as an input means. As the input means, a touch panel mounted on a display surface of a display unit 5 or remote control switches can be used instead of the above-mentioned group of operation switches.

A position detecting unit 2 uses a GPS (Global Positioning System) receiver, a speed sensor, an acceleration sensor, an angular velocity sensor, etc., for example. The position detecting unit 2 detects the current position of a moving object in which the map information processing device is mounted, and provides the processor 4 with position information showing the current position detected thereby.

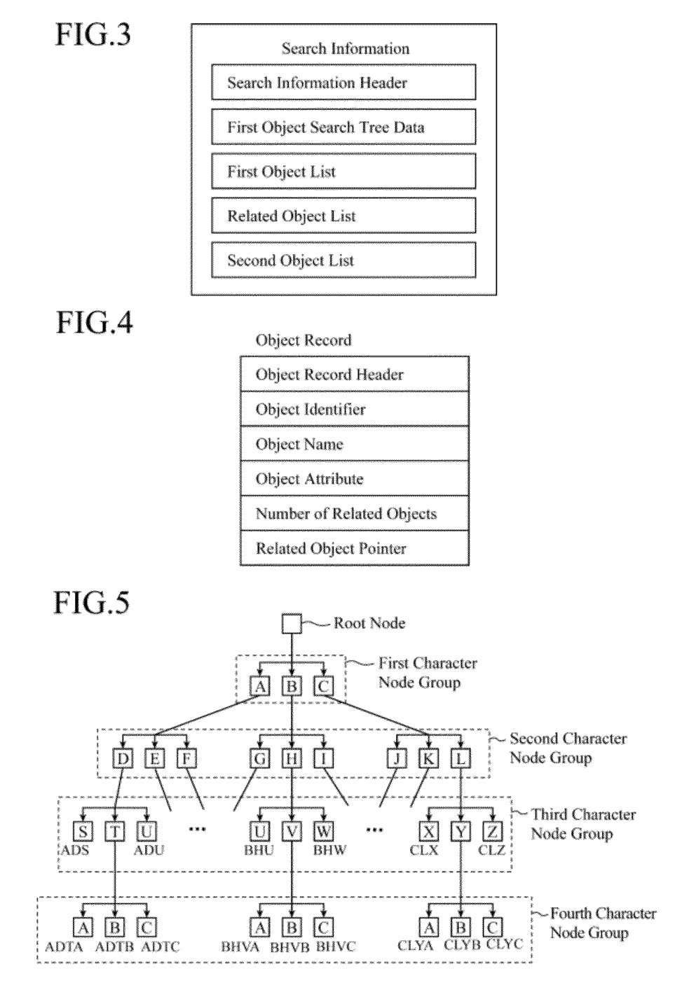

A map information storage unit (storage unit) 3 is comprised of a hard disk drive using a hard disk as a map information storage medium, for example, and map information is stored in the map information storage unit 3 in advance. Further, search information which will be mentioned below with reference to FIGS. 3 to 7 is stored in the map information storage unit 3.

The processor 4 functions as a map information processing part which carries out various map information processes by using the command signal provided thereto from the input unit 1, the position information showing the current position and acquired from the position detecting unit 2, and map information read from the map information storage unit 3.

These various map information process include a map matching process, a route search process, a route display process, a route guiding process, and various search processes.

In this case, the map matching process is the one of estimating the current position of the moving object according to the position information showing the current position and acquired by the position detecting unit 2, and the map information read from the map information storage unit 3. The route search process is the one of determining a route from a place of departure to a destination.

Further, the route display process is the one of displaying candidates for a suitable route which are acquired through the route search process on the display unit 5 together with a road map, and the route guiding process is the one of providing a guidance about a route, which is selected from the above-mentioned candidates for a suitable route, from the place of departure to the destination according to the selected route.

The various search processes are a display process of displaying a map of an area surrounding the current position, and a process of searching for various pieces of information about cities, roads, facilities, addresses, telephone numbers, intersections, etc.

The display unit 5 uses a liquid crystal display or the like, and has a function of displaying a map, the current position of the moving object on the map, the candidates for a suitable route which are acquired through the route search process on the map, guidance information which is used for providing a guidance about the route, which is selected from the candidates for a suitable route, from the place of departure to the destination according to the selected route, various pieces of information used for inputs for searches, various pieces of information which are acquired through these searches, etc. on the basis of the map information which is acquired as a result of the various map information processes carried out by the processor 4.

A sound output unit 6 is a component for providing the user with information which is acquired as a result of the various map information processes carried out by the processor 4 by voice, and has a function of outputting by voice the guidance information which is used for providing the guidance on the suitable route, which is acquired through the route search process on the map, from the place of departure to the destination according to the route, the various pieces of information which are acquired through the searches, etc.

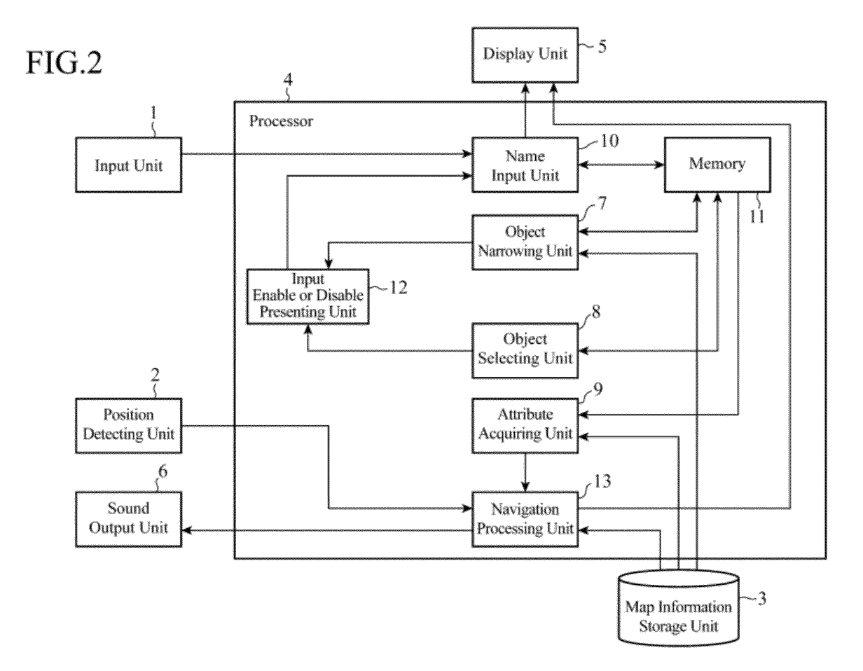

FIG. 2 is a block diagram showing the function configuration of the processor. In the processor shown in FIG. 2, an object narrowing unit 7 is a component for extracting objects each of which satisfies a predetermined requirement from among the objects stored in the map information storage unit 3.

An object selecting unit 8 is a component for selecting an object which the user desires from among the objects extracted by the object narrowing unit 7 by using identifier character information of an identifier of each of the objects.

The identifier character information of the identifier of each object will be mentioned below with reference to FIG. 7. An attribute acquiring unit 9 is a component for acquiring an attribute of the object which is selected by the object selecting unit 8 from a memory 11.

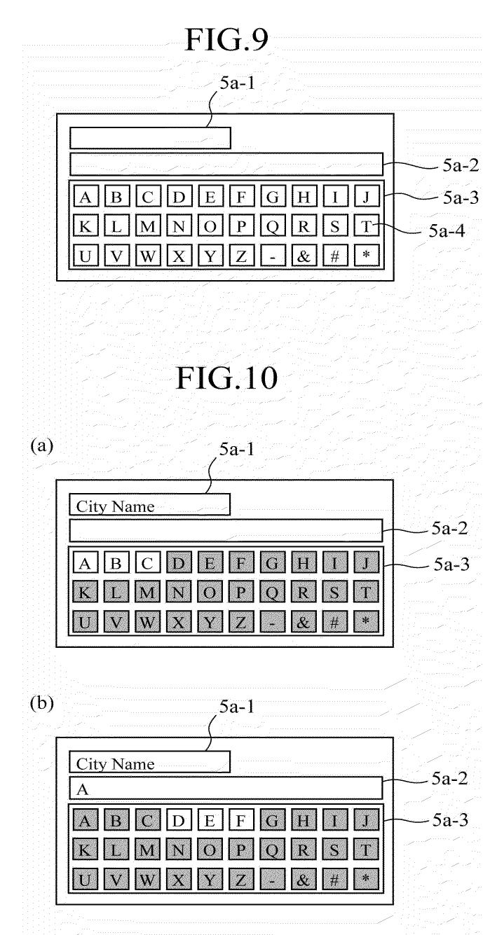

A name input unit 10 is a component for inputting characters showing the name of an object, and controls the display unit 5 to cause this display unit to display an input screen for character input which will be mentioned below with reference to FIG. 9.

The memory 11 stores input character string information to which a character string to be displayed on the input screen for character input is set. Further, data used for the process carried out by the object narrowing unit 7, the process carried out by the object selecting unit 8, and the process carried out by the attribute acquiring unit 9, as well as the input character string information, are stored in the memory 11.

An input enable or disable presenting unit 12 is a component for providing the user with inputtable characters and uninputtable characters which are determined by the object narrowing unit 7 or the object selecting unit 8 when the user inputs each of a predetermined number of characters starting from the first character of a character string showing the name of an object by using the name input unit 10. A navigation processing unit 13 is a component for performing the above-mentioned various map information processes.

The functional configuration of the above-mentioned processor 4 is embodied as a concrete means in which software and hardware work in cooperation with each other by causing the processor 4 to execute a program for map information processes including a program module which implements the above-mentioned functions.

FIG. 3 is a view showing an example of the search information stored in the map information storage unit 3. The search information shown in FIG. 3 is constructed in such a way as to include a search information header, first object search tree data, a first object list, a related object list, and a second object list.

The search information header is data for managing each of the lists and the search tree data which will be shown below.

The first object list is data in which information about objects (first objects), such as streets, cities and facilities, are stored, and is comprised of a row of object records disposed while being respectively associated with the first objects (the object records being arranged in order of increasing record number).

The first object search tree data show a search tree used for searching for a desired object from the objects stored in the first object list.

The second object list is data in which information about objects (second object) of the same type as or of types different from the objects stored in the first object list, and is comprised of a row of object records disposed while being respectively associated with the second objects.

The related object list is data in which information about each second object which is related to a first object is grouped into data about second object groups each related to one of the above-mentioned first objects on a per first object basis according to a predetermined relation, and the data about the second object groups are stored. The related object list is comprised of a row of related object records each disposed while being associated with a pair of a first object and a second object.

The second object groups each related to one of the above-mentioned first objects are referred to as first object related groups.

According to an example of a grouping method, streets which are second objects and each of which is included in a city which is a first object are grouped into groups respectively related to the first objects, streets which are second objects and each of which intersects a street which is a first object are grouped into groups respectively related with the first objects, and facilities which are second objects and each of which is included in a city which is a first object are grouped into groups respectively related with the first objects.

To each first object, a first object identifier for identifying this first object is assigned, and to each second object, a second object identifier for identifying this second object is assigned.

FIG. 4 is a view showing an example of each object record. The object record shown in FIG. 4 is constructed in such a way as to include an object record header, an object identifier, an object name, object attributes, the number of related objects, and related object pointers.

The object record header is information for managing the record, the information including the data size of the record and the type of the attribute stored in the record.

The object identifier is data showing an identifier assigned to the object corresponding to the record. The above-mentioned identifier is information for identifying each object stored in the object list.

The object name is data showing the character string of the name of the object corresponding to the record. The object attributes are data showing various attributes including the latitude and the longitude of the location where the object corresponding to the record is placed, a telephone number, a postal code number, an address, and corresponding links of the object.

The number of related objects is data showing the number of second objects belonging to the related group of the first object corresponding to the record in the related object list.

Each of the related object pointers indicates the related object record at the head of a second object belonging to the related group of the first object corresponding to the record in the related object list.

The related object records including from the related object record indicated by the related object pointer in the related object list to the related object record numbered the number of related objects correspond to the related group of the first object.

In each of the first and second object lists shown in FIG. 3, the object records are aligned in alphabetical order of the corresponding object names.

FIG. 5 is a view showing an example of the search tree expressed by the first object search tree data, and shows the names of the objects stored in the first object list by using a tree structure. Each rectangle in FIG. 5 shows a node which constructs the search tree.

In the search tree, nodes respectively corresponding to the first characters of the names of the above-mentioned objects are disposed as child nodes of the route node positioned at the top of the search tree, nodes respectively corresponding to the second characters of the names of the above-mentioned objects as child nodes of each of the above-mentioned child nodes are disposed in the next hierarchical layer, and child nodes are similarly disposed in each of lower hierarchical layers including up to the required lowest hierarchical layer.

Further, in the above-mentioned search tree, each node having no child node is defined as a leaf node.

Each leaf node has a first object pointer indicating a corresponding first object in the first object list (i.e. the object record of the first object).

By starting from the root node, and then tracing nodes leading to a leaf node toward lower layers, the name of a corresponding first object is acquired.

For example, by stating from the root node, and then tracing the node of “A” which is a first character, the node of “D” which is a second character, the node of “T” which is a third character, and up to the node of “C” which is a fourth character, a name called “ADTC” is acquired. By using the first object pointer of this node (leaf node) of “C” which is a fourth character, the first object having the name called “ADTC” can be acquired from the first object list.

The first object search tree data shown in FIG. 3 are a row of node records disposed while being respectively associated with the above-mentioned nodes. Each node record includes the character of the corresponding node, the first object pointer of the corresponding node (only when this node is a leaf node), the number of the child nodes, the characters of the child nodes, and pointers to the node records of the child nodes.

For example, in the example shown in FIG. 5, the node record of the route node includes a value showing that this node has no character, 3 which is the number of the child nodes, the character A of one of the child nodes and a pointer to the node record of “A” which is a first character, the character B of another one of the child nodes and a pointer to the node record of “B” which is a first character, and the character C of the other one of the child nodes and a pointer to the node record of “C” which is a first character.

Further, the node record of “A” which is a first character includes the character A at this node, 3 which is the number of the child nodes, the character D at one of the child nodes and a pointer to the node record of “D” which is a second character, the character E at another one of the child nodes and a pointer to the node record of “E” which is a second character, and the character F at the other one of the child nodes and a pointer to the node record of “F” which is a second character.

Although the details of the first object search tree data are not explained, the first object search tree data can be defined according to a category data frame described in JIS D0810 “Road vehicles—Map data physical storage format for car navigation systems”, for example.

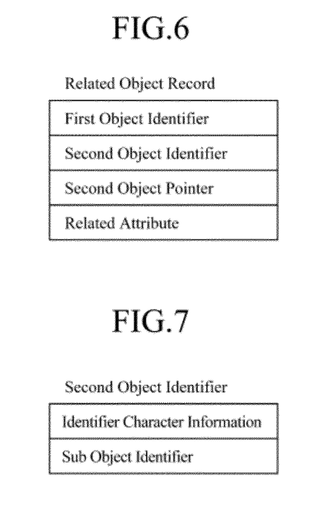

FIG. 6 is a view showing an example of each related object record. The related object record shown in FIG. 6 is constructed in such a way as to include a first object identifier, a second object identifier, a second object pointer, and a related attribute.

In the first object identifier, the identifier of a first object in a related group to which a second object belongs is stored. In the second object identifier, the identifier of the second object is stored. The second object pointer indicates the object record identified by the second object identifier in the second object list.

Further, the related attribute is data showing an attribute in connection with a relation between the first object shown by the first object identifier, and the second object shown by the second object identifier.

For example, when the first object is a city and the second object is a street, and the first and second objects have a relation showing a street included in a city, the related attribute is shown by the latitude and the longitude, or the like which shows a representative position in the city in which the street is included.

Further, when both the first object and the second object are streets, and have a relation showing an intersection of streets, the related attribute is shown by the latitude and the longitude of the intersection of the above-mentioned two streets, or a house number or the like of the intersection.

The related object records are arranged in ascending order of the first object identifiers, and related object records having the same first object identifier are arranged in ascending order of the second object identifiers. As a result, related object records belonging to the same group are aligned continuously.

FIG. 7 is a view showing an example of the second object identifier. The second object identifier shown in FIG. 7 is constructed in such a way as to include identifier character information and a sub object identifier.

The identifier character information consists of the character codes of a predetermined number of characters starting from the head of the name of the second object corresponding to the above-mentioned identifier. For example, when the name of the second object is “ABCDEF” and the predetermined number is “3”, the character code string showing ABC is assigned as the identifier character information.

The sub object identifier is data showing an identifier assigned in order to identify the second object of the second object group specified by the identifier character information.

For example, when the identifier character information shows ABC, and there exist 100 second objects whose names begin with the three characters “ABC”, 0, 1, 2, . . . , and 99 are assigned to the above-mentioned second objects as their sub object identifiers, respectively.

Next, the operation of the map information processing device will be explained.

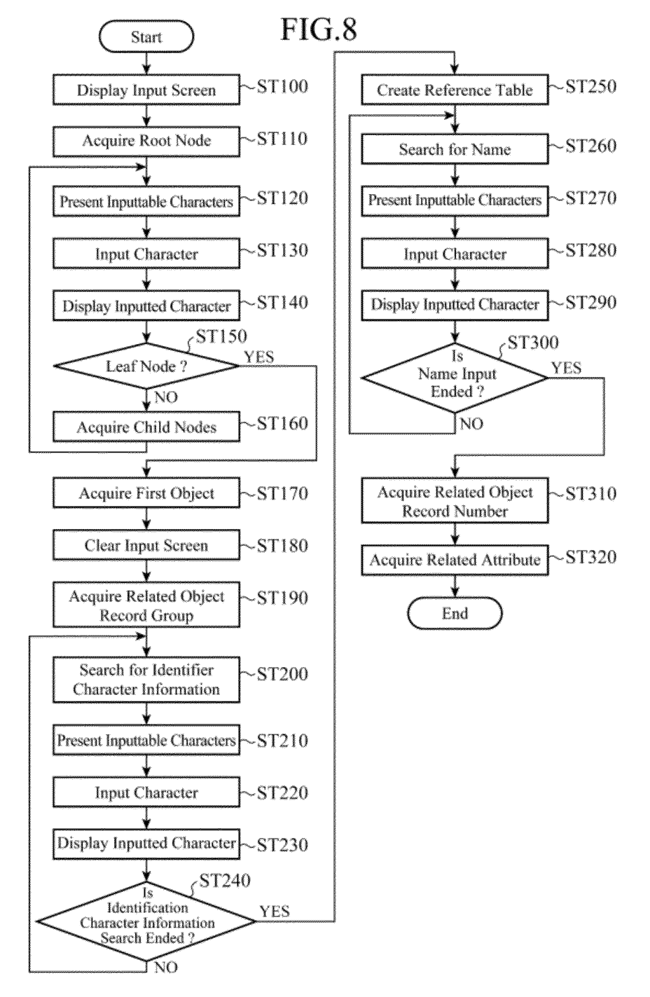

FIG. 8 is a flow chart showing a flow of a search process in accordance with Embodiment 1, and the details of the operation will be mentioned with reference to this FIG. 8. In the following explanation, it is assumed that each first object is a city, and each second object is a street. Further, it is assumed that the first object search tree data shown in FIG. 5 show a search tree used for searching for a city.

Further, the first object list is comprised of a row of object records disposed while being respectively associated with cities. Streets included in cities are grouped into groups by city, and the related object list is comprised of a row of related object records disposed while being respectively associated with pairs of a city and a street. The second object list is comprised of a row of object records disposed while being respectively associated with the streets.

Hereinafter, a case of narrowing down the names of the streets by using a city name and selecting a desired street from the narrowed-down streets will be explained as an example.

First, the name input unit 10 controls the display unit 5 to cause this display unit to display an input screen for inputting characters showing a name (step ST100). FIG. 9 is a view showing an example of this input screen. Referring to FIG. 9, the user is enabled to input an alphabetical character by selecting one of alphabet keys 5a-4 of a keyboard part 5a-3 using the input unit 1.

Although the details of this selecting operation are not shown, the user is enabled to select one of the alphabet keys 5a-4 by operating buttons disposed as the input unit 1 for moving a cursor displayed on the alphabet keys 5a-4 vertically and horizontally, and an enter button disposed as the input unit 1 for commanding the input unit to input a character on an alphabet key 5a-4 at which the cursor is positioned.

The type of an object which should be inputted by using the keyboard part 5a-3 is displayed in an input object indication part 5a-1 shown in FIG. 9. In this case, in order to prompt the user to input a city name, the name input unit displays “City Name” in the input object indication part.

The name input unit displays a character inputted by the user using the keyboard part 5a-3 in a character displaying part 5a-2. At this time, because no character has been inputted yet, the character displaying part 5a-2 has been cleared.

Next, the object narrowing unit 7 acquires the node record of the root node from the first object search tree data stored in the map information storage unit 3, and stores the node record in the memory 11 (step ST110).

The object narrowing unit 7, in step ST120, refers to the node record acquired in the step (step ST110 or step ST160) which the object narrowing unit has performed before advancing to this step ST120, and determines the characters at the child nodes of the node as inputtable characters and also determines the characters at any other nodes as uninputtable characters. These determination results are outputted from the object narrowing unit 7 to the input enable or disable presenting unit 12. By commanding the name input unit 10 to control the display unit 5 according to the determination results, the input enable or disable presenting unit 12 lowers the brightness of each of the alphabet keys 5a-4 corresponding to the uninputtable characters in the keyboard part 5a-3 shown in FIG. 9 to present the inputtable characters and the uninputtable characters to the user in such a way that the user can discriminate between the inputtable characters and the uninputtable characters.

Because the search tree shown in FIG. 5 shows that the map information processing device enables the user to input “A”, “B”, or “C” as a first character in the root node, the input enable or disable presenting unit lowers the brightness of each of the alphabet keys 5a-4 other than A, B, and C keys to display them (toning down display), as shown in FIG. 10(a).

When “A” is selected as the first character, because the search tree shown in FIG. 5 shows on the basis of the child nodes acquired in the process of step ST160, as will be mentioned below, that the user is enabled to input “D”, “E”, or “F” as a second character, the input enable or disable presenting unit lowers the brightness of each of the alphabet keys 5a-4 other than D, E, and F keys to display them, as shown in FIG. 10(b).

The user, in step ST130, selects one of the alphabet keys 5a-4 of the keyboard part 5a-3 by using the input unit 1 to input an alphabetical character to the map information processing device.

Input character string information about a character string constructed of characters displayed in the character displaying part 5a-2 is stored in the memory 11. When the user inputs a character by using the input unit 1, the name input unit 10 adds the inputted character to the input character string information stored in the memory 11.

When any character which cannot be inputted is inputted, the name input unit does not accept the input.

For example, when the user inputs an object name of “ADTC” according to the search tree shown in FIG. 5, the user inputs each of the characters in the order of “A”, “D”, “T”, and “C” by using the input unit 1 every time when the map information processing device advances to step ST130.

Next, the name input unit 10 controls the display unit 5 to cause this display unit to display the input character string information stored in the memory 11 in the character displaying part 5a-2 (step ST140).

Next, the object narrowing unit 7 checks to see the number of child nodes of the node record which the object narrowing unit has acquired currently to determine whether or not the node currently being processed is a leaf node (step ST150).

At time, when the node currently being processed has a child node, the object narrowing unit determines that the node is not a leaf node (when NO in step ST150), the object narrowing unit shifts to a process of step ST160. In contrast, when the node has no child node, the object narrowing unit determines that the node is a leaf node (when YES in step ST150), the object narrowing unit shifts to a process of step ST170.

For example, because when the user, in step ST120, inputs “A”, “D”, “T”, and “C” sequentially in this order by using the input unit 1, the object narrowing unit determines that the node record of the root node, the node record of “A” which is a first character, the node record of “D” which is a second character, and the node record of “T” which is a third character are not leaf nodes according to the search tree shown in FIG. 5, the object narrowing unit shifts to the process of step ST160 after either of the first through third characters is inputted. In contrast, because the node record of “C” which is a fourth character is a leaf node, the object narrowing unit shifts to step ST170 after this character is inputted. In this way, when the city name of “ADTC” is inputted completely, the object narrowing unit shifts to step ST170.

The object narrowing unit 7, in step ST160, refers to the node record which the object narrowing unit has acquired currently, and acquires the node record of the child node corresponding to the character inputted in step ST130 from the first object search tree data and returns to step ST120.

In the search tree shown in FIG. 5, when the object narrowing unit 7 has acquired the node record of the root node currently and the character A is then inputted, the object narrowing unit acquires the node record of the node of “A” in the node group in the first character layer.

Because when the object narrowing unit 7 advances to this step the next time, the object narrowing unit 7 has acquired the node record of the node of “A” in the node group in the first character layer, the object narrowing unit acquires the node record of “D” in the node group in the second character layer when the user inputs the character D.

The object narrowing unit 7, in step ST170, acquires the object record shown by the first object pointer of the node record of the leaf node which the object narrowing unit has acquired currently from the first object list. In this step, the object narrowing unit acquires the object record of the city whose name is “ADTC”.

The object narrowing unit 7, in step ST180, commands the name input unit 10 to control the display unit 5 to cause this display unit to change the displayed characters in the input object indication part 5a-1 to “Street Name” for prompting the user to input a street name, and clear the displayed characters in the character displaying part 5a-2. The object narrowing unit 7 also clears the contents of the input character string information stored in the memory 11.

Next, from the part of the related object list which is shown by the related object pointer of the object record acquired in step ST170, the object narrowing unit 7 acquires a number of related object records whose number is equal to the number of related objects in the object record, and stores the plurality of related object records in the memory 11 (step ST190).

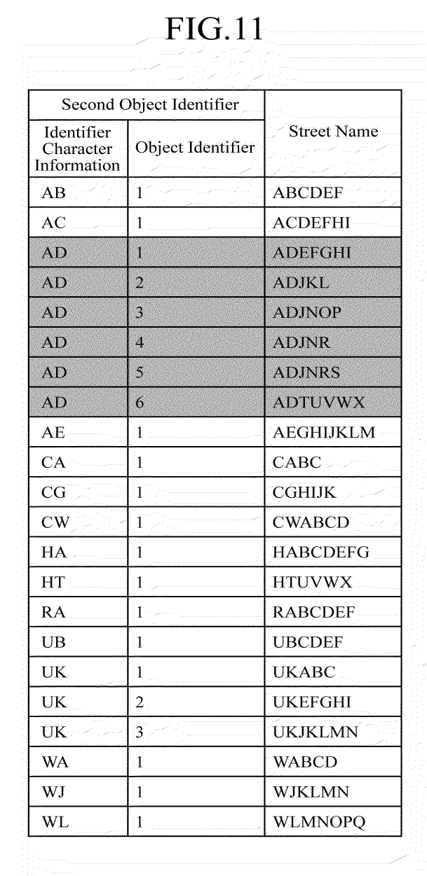

FIG. 11 is a view showing an example of the second object identifiers and the street names of streets in the city whose name is “ADTC”. In the example of FIG. 11, the first object identifiers of the related object records acquired in step ST190 show the city whose name is “ADTC”, and each second object identifier has identifier character information and a sub object identifier as shown in FIG. 11.

The second object list has object records in each of which a second object identifier and a street name shown in FIG. 11 are stored as an object identifier and an object name, respectively.

Further, the related object list has related object records in each of which the object identifier of the city whose name is “ADTC” is stored as the first object identifier, a second object identifier shown in FIG. 11 is stored, and a pointer to an object record in the second object list having a street name shown in FIG. 11 is stored as the second object pointer.

By, in step ST190, acquiring the related object records each having the first object identifier of the city whose name is “ADTC” from the related object list, the object narrowing unit acquires the related object record group corresponding to the pairs of the above-mentioned city and the streets in the above-mentioned city to narrow down the streets which are the search target.

Next, the object selecting unit 8 reads each related object record of the related object record group acquired by the object narrowing unit 7 in step ST190 from the memory 11, and then checks to see the characters shown by the identifier character information of the second object identifier in this related object record (step ST200).

When advancing to step ST200 for the first time, the object selecting unit 8 creates a list of the first characters shown by the identifier character information, and stores the list in the memory 11. When advancing to step ST200 for the second time, the object selecting unit creates a list of the second characters shown by the identifier character information in which the first character of this identifier character information matches a character inputted in step ST220 which will be mentioned below, and stores the list in the memory 11.

After that, when advancing to the above-mentioned step for the n-th (n=3, 4, . . . ) time, the object selecting unit similarly creates a list of the n-th characters shown by the identifier character information in which the first through (n−1)-th characters of this identifier character information matches a character string inputted in step ST220 until now, and stores the list in the memory 11.

When advancing to the above-mentioned step for the first time, the object selecting unit 8 creates a list of the first characters “A, C, H, R, U, W” shown by the identifier character information shown in, for example, FIG. 11, and, when advancing to the step for the second time, the object selecting unit creates a list of the second characters “B, C, D, E” shown by the identifier character information in which the first character is “A” and matches the character inputted in step ST220 when this character is “A”, as shown in FIG. 11.

The object selecting unit in accordance with the present invention can thus create the above-mentioned list by simply referring to the identifier character information of the second object identifier of each related object record in the related object record group. Therefore, the object selecting unit does not have to acquire the name of each second object in the second object list, and can shorten the time required to create the above-mentioned list.

The object selecting unit 8, in step ST210, refers to the contents of the memory 11, and determines that the characters existing in the list created in step ST200 are inputtable characters and also determines that the other characters are uninputtable characters. These determination results are outputted from the object selecting unit 8 to the input enable or disable presenting unit 12.

According to the inputted determination results, the input enable or disable presenting unit 12 commands the name input unit 10 to control the display unit 5 to cause this display unit to lower the brightness of each of the alphabet keys 5a-4 corresponding to the uninputtable characters to present the inputtable characters and the uninputtable characters to the user in such a way that the user can discriminate between the inputtable characters and the uninputtable characters.

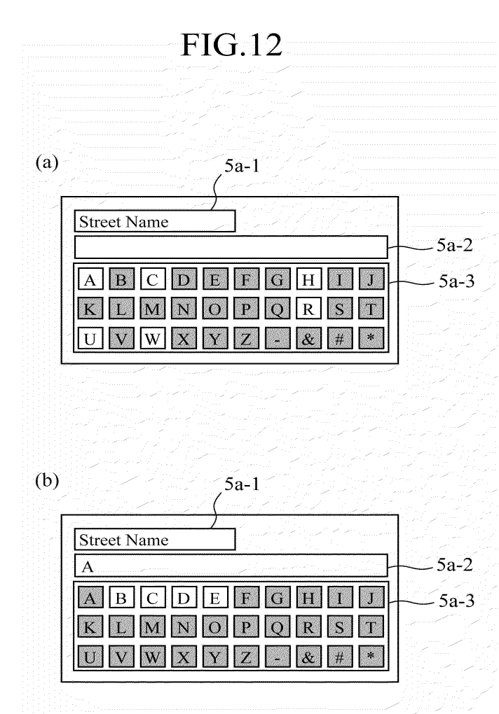

When the first character is inputted, the input enable or disable presenting unit lowers the brightness of each of the alphabet keys 5a-4 other than the A, C, H, R, U, and W keys, as shown in FIG. 12(a). When the second character is inputted, the input enable or disable presenting unit lowers the brightness of each of the alphabet keys 5a-4 other than the B, C, D, and E keys, as shown in FIG. 12(b).

When the user, in step ST220, selects one of the alphabet keys 5a-4 of the keyboard part 5a-3 by using the input unit 1, an alphabetical character is inputted.

When the user inputs a character by using the input unit 1, the name input unit 10 adds the inputted character to the input character string information stored in the memory 11.

The object selecting unit 8 compares the inputted character with the list created in step ST200, and, when the object selecting unit determines that any character which cannot be inputted is inputted, the name input unit does not accept the input.

Because the object selecting unit can carry out the creation of the list in step ST200 in a short time by doing in this way, the object selecting unit can carry out the presentation of the inputtable characters and the uninputtable characters in step ST210 in a short time, thereby enabling the user to input a character in a smooth way and in a short time.

The name input unit 10 controls the display unit 5 to cause this display unit to display the characters shown by the input character string information stored in the memory 11 (the characters inputted in step ST220) in order in the character displaying part 5a-2 of the input screen (step ST230).

The object selecting unit 8, in step ST240, determines whether the object selecting unit has completed the processes of steps ST200 to ST230 a number of times corresponding to the number of characters stored as the identifier character information.

When the object selecting unit has completed the processes the number of times (when YES in step ST240), the object selecting unit shifts to a process of step ST250, whereas when the object selecting unit has not completed the processes the number of times (when NO in step ST240), the object selecting unit returns to the process of step ST200.

The object selecting unit 8, in step ST250, refers to the contents of the memory 11, and, for each related object record having the second object identifier whose character string of the identifier character information matches the character string inputted in step ST220, creates a reference record consisting of the record number of the above-mentioned related object record, which is included in the related object record group which the object narrowing unit 7 has acquired in step ST190, and the second object pointer in the above-mentioned related object record. The object selecting unit 8 further creates a reference table consisting of those reference records and stores the reference table in the memory 11.

For example, when “A” is inputted to as the first character in step ST220, and “D” is then inputted as the second character, the object selecting unit 8 creates reference records respectively consisting of the record numbers of related object records and their second object pointers, each of the related object records having AD as its identifier character information of the second object identifier shaded in FIG. 11, and the sub object identifiers of the related object records being 1 to 6, respectively. The object selecting unit 8 then creates a reference table consisting of these reference records.

The second object pointer in each of the reference records in the above-mentioned reference table points to the corresponding object record in the second object list having a street name shaded in FIG. 11.

The object selecting unit 8 refers to the second object pointer in each of the reference records of the reference table, and checks to see the third and subsequent characters of the object name of the object record in the second object list which is shown by the second object pointer (step ST260).

When advancing to this step for the first time, the object selecting unit 8 creates a list of the third characters of the object names, and stores this list in the memory 11. When advancing to the above-mentioned step for the second time, the object selecting unit 8 creates a list of the fourth characters of the object names each of whose third characters matches a character inputted in step ST280 until now, and stores the list in the memory 11. After that, when advancing to the above-mentioned step for the n-th (n=3, 4, . . . ) time, the object selecting unit similarly creates a list of the (n+3)-th characters of the object names each of whose third through (n+3−1)-th characters match characters inputted in step ST280 until now, and stores the list in the memory 11.

For example, in a case in which “J”, “N”, and “R” are, in step ST280, inputted in this order, when having advanced to the step for the first time, the object selecting unit 8 creates a list “E, J, T” of the third characters of the character strings shown by the identifier character information for the street names shaded in FIG. 11.

Then, when having advanced to the step for the second time, the object selecting unit 8 creates a list “K, N” of the fourth characters of the object names each of whose third characters matches “J” because the character inputted as the third character in step ST220 is “J”.

Then, when having advanced to the step for the third time, the object selecting unit 8 creates a list “O, R” of the fifth characters of the object names each of whose third characters matches “J” and each of whose fourth characters matches “N” because the character inputted as the fourth character in step ST280 is “N”.

Then, when having advanced to the step for the fourth time, the object selecting unit 8 creates a list “S” of the six characters of the object names each of whose third characters matches “J”, each of whose fourth characters matches “N” and each of whose fifth characters matches “R” because the character inputted as the fifth character in step ST280 is “R”.

The object selecting unit in accordance with the present invention can thus create the above-mentioned list by simply referring to the object names of the object records in the second object list registered in the above-mentioned reference table. Therefore, the object selecting unit does not have to acquire the names of all the second objects in the second object list, and can shorten the time required to create the above-mentioned list.

The object selecting unit 8, in step ST270, determines that the characters existing in the list created in step ST260 are inputtable characters and also determines that the other characters are uninputtable characters, and outputs these determination results to the input enable or disable presenting unit 12.

When receiving these determination results, the input enable or disable presenting unit 12 controls the display unit 5 to cause this display unit to lower the brightness of each of the alphabet keys 5a-4 of the keyboard part 5a-3 corresponding to the uninputtable characters to present the inputtable characters and the uninputtable characters to the user.

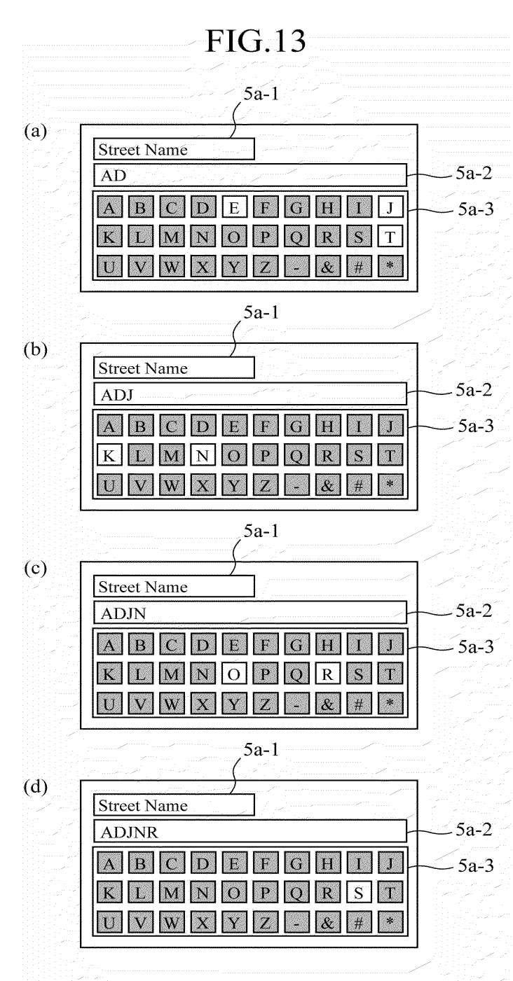

In the above-mentioned example, when the user inputs the third character, the input enable or disable presenting unit lowers the brightness of each of the alphabet keys other than the E, J, and T keys, as shown in FIG. 13(a). When the user inputs the fourth character, the input enable or disable presenting unit lowers the brightness of each of the alphabet keys other than the K and N keys, as shown in FIG. 13(b). When the user inputs the fifth character, the input enable or disable presenting unit lowers the brightness of each of the alphabet keys other than the O and R keys, as shown in FIG. 13(c). When the user inputs the sixth character, the input enable or disable presenting unit lowers the brightness of each of the alphabet keys other than the S key, as shown in FIG. 13(d).

The user, in step ST280, selects one of the alphabet keys 5a-4 of the keyboard part 5a-3 by using the input unit 1 to input an alphabetical character.

The name input unit 10 adds the inputted character to the input character string information stored in the memory 11. The object selecting unit 8 compares the inputted character with the list created in step ST260, and, when the object selecting unit determines that any character which cannot be inputted is inputted, the name input unit 10 does not accept the input.

Thus, the object selecting unit in accordance with the present invention can shorten the time required to create the list in step ST260, and, as a result, the object selecting unit can reduce the time required to present the inputtable characters and the uninputtable characters in step ST280. As a result, the user can input a character in a smooth way and in a short time.

The name input unit 10 controls the display unit 5 to cause this display unit to display the characters shown by the input character string information stored in the memory 11 (the characters inputted in step ST280) in order in the character displaying part 5a-2 of the input screen (step ST290). In this step, the input character string as shown in FIGS. 13(a) to 13(d) is displayed in the character displaying part 5a-2 of the input screen.

Next, the name input unit 10 determines whether the user has issued a command for ending the name input by using the input unit 1 (step ST300). When determining that the user has issued a command for ending the name input (when YES in step ST300), the name input unit shifts to a process of step ST310, whereas when determining that the user has not issued a command for ending the name input (when NO in step ST300), the name input unit returns to the process of step ST260.

After inputting “R” as the fifth character, when the user issues a command for ending the name input, it can be judged that the user had decided “ADJNR” as the street name as shown in FIG. 13(d). At this time, through the process of step ST280, the character string of ADJNR is stored in the input character string information in the memory 11.

The object selecting unit 8, in step ST310, checks to see the reference records of the reference table created in step ST250 to search for a reference record in which the object name of the object record in the second object list to which the second object pointer of the reference record points matches the character string shown by the input character string information, and stores the record number in the reference record which the object selecting unit has acquired as the search result in the memory 11 as a purpose-related object record number.

The attribute acquiring unit 9, in step ST320, specifies the related object record in the related object list stored in the map information storage unit 3 on the basis of the purpose-related object record number stored in the memory 11, acquires the related attribute included in the related object record, and ends the search process.

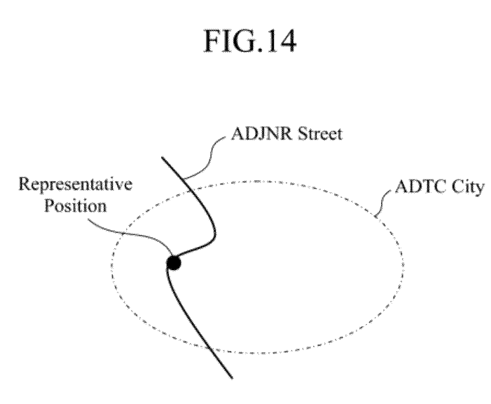

Through this step, the attribute acquiring unit acquires, for example, a latitude and a longitude showing a representative position of the street having a name of “ADJNR” in the city having a name of “ADTC” shown in FIG. 14, as the related attribute.

The attribute acquiring unit 9 outputs the representative position acquired in this step to the navigation processing unit 13. The navigation processing unit 13 uses the information showing this representative position for specification of a map display position, and for a setup of a destination or the like in a route search.

As mentioned above, the map information processing device in accordance with this Embodiment 1 extracts objects each of which has a relation with another object satisfying a predetermined requirement (for example, refer to the search tree data shown in FIG. 5) from among objects each of which is a search target, and prompts the user to input the name of an object according to a row of characters defined by identifier character information showing a row of a predetermined number of characters from the head of a character string showing the name of each of the objects to select an object which the user desires from among the objects extracted thereby.

By doing in this way, the map information processing device can shorten the time required to determine characters which can be inputted thereto the next time when the user inputs the name of an object, and can improve its ease of use of the input of a name.

Further, the map information processing device in accordance with this Embodiment 1 includes the name input unit 10 for accepting an input of characters showing the name of an object, and the input enable or disable presenting unit 12 for presenting the characters which can be inputted the next time and the characters which cannot be inputted the next time when the name input unit 10 receives an input of a predetermined number of characters from the head of a character string showing the name of the object, and selects an object which the user desires from among the objects extracted by the object narrowing unit 7 by receiving the input of the name of the object by using the name input unit 10 while the object selecting unit 8 causes the input enable or disable presenting unit 12 to present the characters which can be inputted and the characters which cannot be inputted according to a row of characters defined by identifier character information.

Because the map information processing device thus acquires the characters which can be inputted the next time from the identifier character information when the user inputs a name to select an object from among the narrowed-down objects, the map information processing device can reduce the time required to determine the characters which can be inputted, and improve its ease of use.

In addition, in the map information processing device in accordance with this Embodiment 1, when the name input unit 10 accepts an input of each character of a character string showing the name of an object after receiving a predetermined number of characters from the head of the character string, the object selecting unit 8 specifies the objects each defined by the identifier character information matching the predetermined number of characters from the head of the character string the input of which has been accepted by the name input unit 10 from among the objects extracted by the object narrowing unit 7, and causes the input enable or disable presenting unit 12 to present the characters which can be inputted and the characters which cannot be inputted according to the character strings of the names of the above-mentioned objects.

Particularly, the identifier character information is constructed of a row of the character codes of a predetermined number of characters from the head of a character string showing the name of an object.

Because the identifier character information is constructed in this way, after a predetermined number of characters is inputted when the user inputs a name at the time of selecting an object from among the narrowed-down objects, the map information processing device limits objects to be referred to for the determination of the characters which can be inputted the next time according to the characters which have been inputted until then. As a result, the map information processing device can reduce the time required to determine the characters which can be inputted, and improve its ease of use.

Although in above-mentioned Embodiment 1, the keyboard part 5a-3 on the input screen which enables the user to perform an input of alphabetical characters is shown as an example, the keyboard part 5a-3 can be alternatively constructed in such a way as to have 50 phonetic character keys and enable the user to perform an input with 50 phonetic characters instead of alphabetical characters.

### Embodiment 2

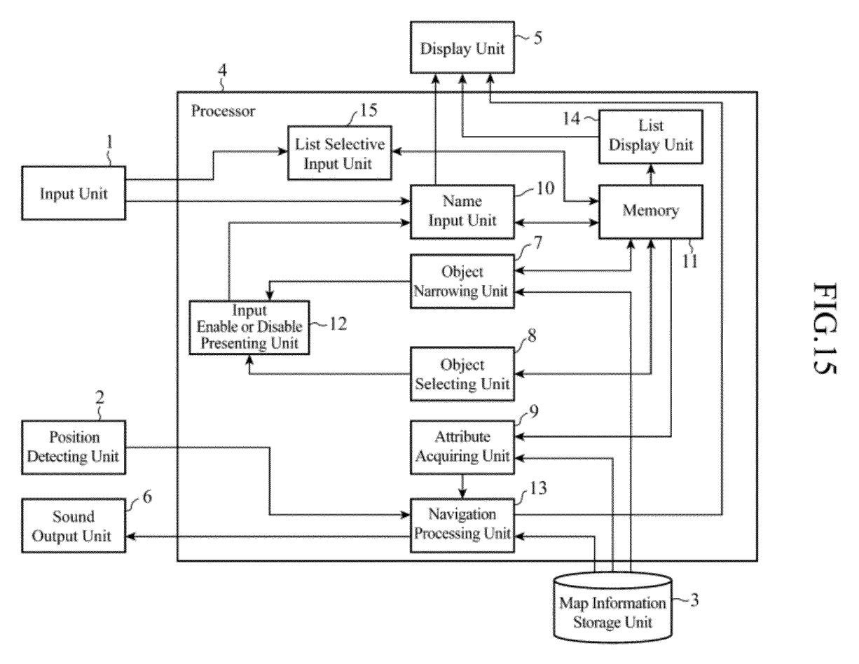

FIG. 15 is a block diagram showing the function configuration of a processor of a map information processing device in accordance with Embodiment 2 of the present invention. As shown in FIG. 15, the processor 4 in accordance with Embodiment 2 is provided with a list display unit 14 and a list selective input unit 15 in addition to the function configuration shown in Embodiment 1.

The list display unit 14 is a component for controlling a display unit 5 to cause this display unit to display a list of the names of objects extracted by an object narrowing unit 7, each of the names being included in a character string inputted by a name input unit 10.

The list selective input unit 15 is a component for accepting an input of information from an input unit 1, and specifies a name which the user desires from among names displayed by the list display unit 14 according to the input information inputted by using the input unit 1.

Next, the operation of the map information processing device will be explained.

The map information processing device in accordance with this Embodiment 2 additionally performs an operation of listing objects for a search process carried out by the map information processing device in Embodiment 1, and selecting an object which the user desires. Concretely, in between steps ST270 and ST280 of FIG. 8 shown in Embodiment 1, the map information processing device lists objects and selects an object which the user desires from this list.

Further, list display necessity information showing whether or not there is a necessity to display the list is stored in a memory 11 of the processor 4. Prior to the above-mentioned search process, this list display necessity information is set according to a command inputted from the user using the input unit 1.

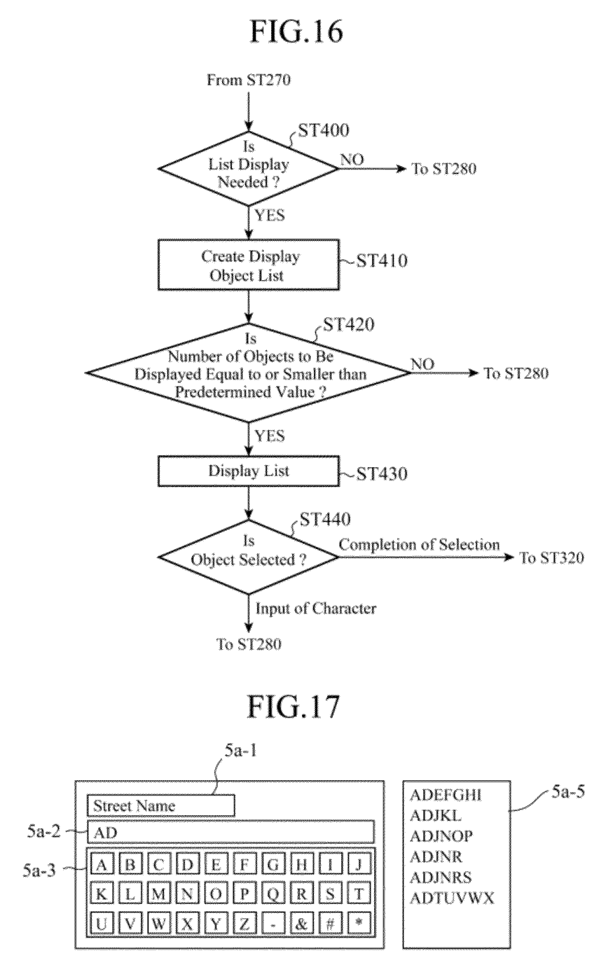

FIG. 16 is a flow chart showing a flow of an object selection process in accordance with Embodiment 2, and shows the above-mentioned operation of listing objects and selecting an object which the user desires.

When a process of step ST270 shown in FIG. 8 is completed, the list selective input unit 15 determines whether or not there is a necessity to display the list from the contents of the list display necessity information stored in the memory 11 (step ST400). At this time, when determining that there is a necessity to display the list (when YES in step ST400), the list selective input unit shifts to step ST410, whereas when determining that there is no necessity to display the list (when NO in step ST400), the list selective input unit shifts to step ST280 and does not perform the display of the list.

The list selective input unit 15, instep ST410, acquires a reference record in which the object name of an object record to which the second object pointer of the reference record points includes the character string stored in the input character string information stored in the memory 11 from among reference records in a reference table created by an object selecting unit 8 in step ST250, and sets the reference record acquired thereby to a display object list stored in the memory 11. The display object list is information to which the objects listed by the list display unit 14 are set.

The list selective input unit 15 then determines whether or not the number of the reference records stored in the display object list in step ST410 is equal to or smaller than a predetermined number (step ST420). When the number of the reference records is equal to or smaller than the predetermined number (when YES in step ST420), the list selective input unit shifts to a process of step ST430, whereas when the number of the reference records exceeds the predetermined number (when NO in step ST420), the list selective input unit shifts to step ST280 and does not perform the display of the list. The predetermined number can be the number of reference records which can be listed on a single display screen.

The list display unit 14, in step ST430, controls the display unit 5 to cause this display unit to display the object name of the object record in the second object list to which the second object pointer of each of the reference records of the display object list stored in the memory 11 points on the display screen in the order in which the reference records are aligned in the display object list.

When being unable to display all the above-mentioned object names in a list display part of the display screen, the list display unit 14 controls the display unit 5 to cause this display unit to display a screen on which the list display unit scrolls and displays the object names upwardly or downwardly according to a scroll command inputted by using the input unit 1.

FIG. 17 is a view showing an example of the list display part of the input screen. The example of FIG. 17 shows a case in which street names shaded in FIG. 11 are displayed in the list display part 5a-5 of the input screen when the list display unit has advanced to the above-mentioned step after the characters A and D are inputted by using the input unit 1.

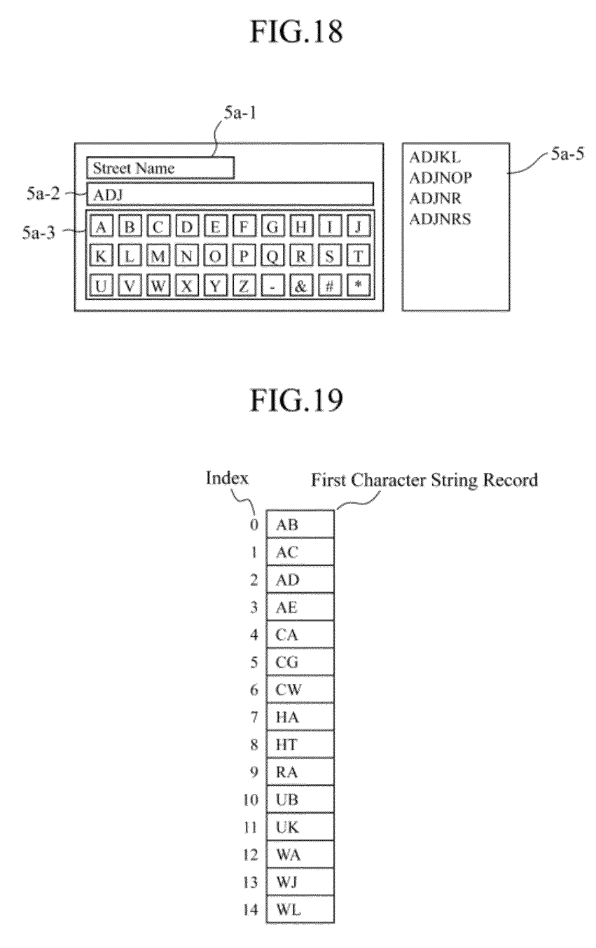

Further, FIG. 18 shows a display example in which street names are displayed in the list display part when the list display unit has advanced to the above-mentioned step after the characters A, D and J are inputted by using the input unit 1. In the example shown in FIG. 18, ADEFGHI and ADTUVWX each of whose third characters is not “J” are removed from the list display part 5a-5 shown in FIG. 17 because of the input of the character J.

The list selective input unit 15, in step ST440, accepts the user's selection of an object based on the contents of the list display part 5a-5. At this time, the user is enabled to select a desired object by moving a cursor on the names displayed in the list display part 5a-5 (on a name display) by using the input unit 1. When receiving a determination of the selection by using the input unit 1, the list selective input unit 15 stores the record number in the reference record corresponding to the selected object in the memory 11 as a purpose-related object record number, and shifts to step ST320 by assuming that the object selection has been completed.

Further, when being commanded to further receive a character input using the input unit 1, the map information processing device shifts to step ST280 as a process of the name input unit 10, and carries out the next character input.

The user is enabled to select an object in this way while looking at a list of the names of objects which are candidates for selection. In addition, because the number of object names to be listed is narrowed down, the recognition of the objects which are candidates for selection can be facilitated. Further, the user is enabled to select an object without having to input all characters.

The plurality of object names to be displayed are listed when the number of the object names is equal to or smaller than the predetermined value in step ST420 of the above-mentioned processing. As an alternative, the process of step ST420 can be eliminated and the plurality of object names to be displayed can be listed regardless of the number of the object names to be displayed.

As mentioned above, because the map information processing device in accordance with this Embodiment 2 includes the list display unit 14 for displaying a list of the names of objects extracted by the object narrowing unit 7, each of the names including a character string an input of which has been accepted by the name input unit 10, the map information processing device can present the list of object names which are candidates for selection to the user.

Further, because the map information processing device in accordance with this Embodiment 2 includes the list selective input unit 15 for accepting a selective input of the name of an object from among the names of the objects listed by the list display unit 14, the user is enabled to select a desired name from the list of object names which are candidates for selection.

In addition, in the map information processing device in accordance with this Embodiment 2, when the number of objects including the character string an input of which has been accepted by the name input unit 10, the objects being included in the objects extracted by the object narrowing unit 7, is equal to or smaller than the predetermined number, the list display unit 14 lists the names of the objects.

By doing in this way, because the list display unit 14 lists the names of these objects only when the selection of an object from the list is facilitated according to the number of objects which are candidates for selection, the user's operation can be facilitated.

### Embodiment 3

In this Embodiment 3, first character string information consisting of a first character string record corresponding to a second object identifier shown in Embodiments 1 and 2, and storing a row of the character codes of a predetermined number of characters starting from a first character of a character string showing the name of a second object is disposed in a map information storage unit 3. More specifically, in Embodiment 3, by using, as the identifier character information of a second object identifier shown in Embodiments 1 and 2, an index in the first character string information of a first character string record storing a character string which the identifier character information should express, the data size of the identification character information is reduced.

FIG. 19 is a view showing an example of the first character string information in Embodiment 3. In the example shown in FIG. 19, the number of characters shown by each identifier character information is set to “2”, and each identifier character information shown in FIG. 11 in above-mentioned Embodiment 1 is defined as a first character string record. Each first character string information has no first character string record having the same character string.

In this Embodiment 3, the identifier character information of a second object having a street name of “ADJNR” shown in FIG. 11 is shown by “2” which is the index of the first character string record having a character string of AD, as shown in FIG. 19.

Further, in accordance with this Embodiment 3, the process of referring to a character string in each identifier character information shown in Embodiments 1 and 2 is changed to a process of referring to the character string in the first character string record of the first character string information shown by the index of each identifier character information.

In a case in which a combination of the characters of the character string shown by each identifier character information is limited to one of combinations of characters as shown in FIG. 19, for example, the use of a character string in ASCII codes as each identifier character information requires 2 bytes, while the use of indexes as shown in FIG. 19 can represent each identifier character information with 4 bits.

Thus, in the case in which the combination of the characters of the character string shown by each identifier character information is limited, the above-mentioned use of indexes can reduce the data size of each identifier character information as compared with the case in which a character string is used as each identifier character information.

As mentioned above, because the map information storage unit 3 in accordance with this Embodiment 3 stores first character string information storing a first character string record showing a row of the character codes of a predetermined number of characters from the head of a character string showing the name of each object in such a way that no other first character string record whose row of character codes matches the row of character codes exists, and the identifier character information is an index value of the first character string information, the map information processing device can reduce the data size of each identifier character information by using the above-mentioned index.

### Embodiment 4

Although the case in which each first object is a city, and each second object is a street is shown as an example in Embodiment 1, Embodiment 2, and Embodiment 3, a case in which each first object is a street, like each second object, and an intersection relation between streets is defined as a relation between first and second objects is shown in Embodiment 4.

In this case, because a first object list has the same contents as a second object list, the second object list is used instead of the first object list while no first object list is disposed.

A related object list consists of a row of related object records each disposed while being associated with a pair of a street which is a first object and another street which has an intersection relation with the first object and which is a second object.

Further, in the second object list, the number of related objects in each object record shows the number of streets each of which intersects the street, and a related object pointer points to the leading related object record of the street group which intersects the street.

Because a first object identifier of each related object record in the related object list stores the identifier of a street, instead of the identifier of a city, unlike that in accordance with the above-mentioned embodiment, the first object identifier is stored in the same form as that in which a second object identifier is stored.

In addition, although first object search tree data in which the name of each street stored in the second object list, instead of a city name, is expressed by using a tree structure are used, the data structure of the first object search tree data is the same as that shown in Embodiments 1, to 3.

A search process carried out by the map information processing device in accordance with Embodiment 4 is the same as those in accordance with Embodiments 1 to 3, except for the above-mentioned difference.

When the user inputs the name of a street, instead of a city name, by using the input unit 1, like in the cases of Embodiments 1 to 3, the map information processing device selects a street which the user desires from the group of streets each of which intersects the above-mentioned street, and acquires an attribute, such as the latitude and the longitude of the intersection where the above-mentioned two streets intersect.

As mentioned above, in the map information processing device in accordance with this Embodiment 4, the map information storage unit 3 defines streets as objects each of which is a search target, and stores intersection information about a location where a street intersects another street as an attribute of the street as well as an object identifier including identifier character information showing a row of a predetermined number of characters from the head of a character string showing the name of the street, the object narrowing unit 7 extracts a street having a relation of intersecting a specified street from among streets stored in the map information storage unit 3, the object selecting unit 8 prompts the user to input the name of a street according to the row of characters defined by the identifier character information to select a street which the user desires from among the streets extracted by the object narrowing unit 7, and the attribute acquiring unit 9 acquires the intersection information about the street selected by the object selecting unit 8 from the map information storage unit 3 as data used for the map information process on the street. Because the map information processing device can search for an intersection between two streets in a short time more by doing in this way, the map information processing device can improve its ease of use for input of the name of a street.

Although in above-mentioned Embodiments 1 to 4, the number of characters shown by each identifier character information is two, each identifier character information can be formed in such a way as to show one character or three or more characters.

Further, although the case in which the objects are narrowed down by using a search tree in the processes of steps ST100 to ST170 shown in FIG. 8 is shown, the objects can be narrowed down alternatively by using a method of listing objects and selecting some of them.

Further, although in above-mentioned Embodiments 1 to 4, the case in which the map information process is carried out by defining cities or streets as first objects or second objects is shown, a music search process can be alternatively carried out by defining audio data, such as artist names, album titles or music names, having a hierarchical structure which can be applied to a search tree shown in FIG. 5 as objects, for example.

### INDUSTRIAL APPLICABILITY

Because the map information processing device in accordance with the present invention can shorten the time required to determine characters which can be inputted thereto the next time when the user inputs the name of an object, and can improve its ease of use of the input of a name, the map information processing device in accordance with the present invention is suitable for a vehicle-mounted navigation system and so on which are required to provide a certain degree of ease of use.

1. A map information processing device comprising:
a storage unit for storing, for each of objects which is a search target, a character string showing a name of said object, an object identifier including identifier character information showing a row of a predetermined number of characters from a head of the character string showing the name of said object and a sub object identifier which is a number for identifying objects each of whose names includes the row of the characters of said identifier character information at a head thereof, and an attribute of said object;
an object narrowing unit for extracting objects having a relation therebetween which satisfies a predetermined requirement from among the objects stored in said storage unit;
an object selecting unit for selecting an object which a user desires from among the objects extracted by said object narrowing unit by prompting the user to input a name of one of said objects according to a row of characters defined by said identifier character information; and
an attribute acquiring unit for acquiring an attribute of the object selected by said object selecting unit from said storage unit as data which is used for a map information process on said object.

2. The map information processing device according to claim 1, wherein said map information processing device includes a name input unit for accepting an input of a character showing the name of said object, and an input enable or disable presenting unit for presenting characters which can be inputted next time and characters which cannot be inputted next time when said name input unit receives an input of a predetermined number of characters from a head of a character string showing the name of said object, and said object selecting unit selects an object which the user desires from among the objects extracted by said object narrowing unit by receiving an input of the name of said object by using said name input unit while causing said input enable or disable presenting unit to present the characters which can be inputted and the characters which cannot be inputted according to the row of characters defined by said identifier character information.

3. The map information processing device according to claim 2, wherein when said name input unit accepts an input of each character after receiving the predetermined number of characters from the head of the character string showing the name of said object, said object selection unit specifies an object having identifier character information which matches the predetermined number of characters from the head of the character string the input of which has been accepted by said name input unit from the objects extracted by said object narrowing unit, and causes said input enable or disable presenting unit to present the characters which can be inputted next time and the characters which cannot be inputted next time according to a character string of a name of said object specified thereby.

4. The map information processing device according to claim 2, wherein said map information processing device has a list display unit for listing names of objects, among the objects extracted by said object narrowing unit, each including a character string an input of which is accepted by said name input unit.

5. The map information processing device according to claim 4, wherein said map information processing device has a list selective input unit for accepting an selective input of a name of an object among the names of the objects listed by said list display unit.

6. The map information processing device according to claim 4, wherein when a number of the objects, among the objects extracted by said object narrowing unit, each including a character string an input of which is accepted by said name input unit is equal to or smaller than a predetermined number, said list display unit lists the names of said objects.

7. The map information processing device according to claim 1, wherein said identifier character information is a row of character codes of the predetermined number of characters from the head of the character string showing the name of the object.

8. The map information processing device according to claim 1, wherein said storage unit stores first character string information storing a first character string record showing a row of character codes of the predetermined number of characters from the head of the character string showing the name of the object in such a way that no other first character string record whose row of alphabetic codes matches said row of character codes exists, and said identifier character information is an index value of said first character string information.

9. The map information processing device according to claim 1, wherein said storage unit defines streets as objects each of which is a search target, and stores intersection information about a location where one of said streets intersects another street as an attribute of said street as well as the object identifier including the identifier character information showing the row of the predetermined number of characters from the head of the character string showing the name of said street, said object narrowing unit extracts a street having a relation of intersecting a specified street from among the streets stored in said storage unit, said object selecting unit prompts the user to input the name of one of said streets according to the row of characters defined by said identifier character information to select a street which the user desires from among the streets extracted by said object narrowing unit, and said attribute acquiring unit acquires the intersection information about said street selected by said object selecting unit from said storage unit as data used for the map information process on said street.
